(19) United States
(12) Patent Application Publication
(10) Pub. No.: US 2018/0096275 A1
(43) Pub. Date: Apr. 5, 2018

(54) APPARATUS AND METHOD TO MANAGE ONSITE WORK

(71) Applicant: FUJITSU LIMITED, Kawasaki-shi (JP)

(72) Inventors: Takuya Akutsu, Kawasaki (JP); Hidekazu Arai, Kawasaki (JP)

(73) Assignee: FUJITSU LIMITED, Kawasaki-shi (JP)

(21) Appl. No.: 15/704,626

(22) Filed: Sep. 14, 2017

(30) Foreign Application Priority Data
Sep. 30, 2016 (JP) 2016-194225

(51) Int. Cl. G06Q 10/06; H04W 4/02

(52) U.S. Cl. CPC G06Q 10/06316; H04W 4/02; G06Q 10/063114

(57) ABSTRACT

An apparatus receives, from a terminal, terminal-location information indicating a location of the terminal carried by a worker, work-start information indicating a start of work designated by a work-instruction for instructing the worker to perform work, and work-end information indicating an end of work designated by the work-instruction. The apparatus transmits a control signal for causing the terminal to enter a state in which work-start information indicating a start of work designated by the work-instruction is transmittable, based on a result of comparison between the terminal-location information and work-instruction location information indicating a location at which work designated by the work-instruction is to be performed by the worker. The apparatus compares standard-work information indicating a standard for the worker to perform work designated by the work-instruction, with actual-work information that is calculated based on the work-start information and the work-end information, and outputs information on a result of the comparing.

### CROSS-REFERENCE TO RELATED APPLICATION

This application is based upon and claims the benefit of priority of the prior Japanese Patent Application No. 2016-194225, filed on Sep. 30, 2016, the entire contents of which are incorporated herein by reference.

### FIELD

The embodiments discussed herein are related to apparatus and method to manage onsite work.

### BACKGROUND

For example, there is a case in which an inquiry from a customer is accepted at a call center, and an engineer is instructed to perform onsite maintenance (home-visit repair) from the call center when maintenance support service of an information communication device product or the like is provided. In such a case, at the call center, it is difficult to accurately grasp whether the engineer actually has visited the customer and has performed work.

There is a technology by which work management of a worker such as an engineer that performs the above-described onsite maintenance is supported. For example, a system has been proposed in which a route and map to go to a visit destination are provided to a mobile terminal device used by a sales person in accordance with action schedule set in advance. In such a system, the visit destination to which the sales person may move is extracted in accordance with the action schedule or the action result of the sales person, and the route and the map to go to the visit destination are provided to the mobile terminal device each time the extraction is performed, and the action result of the sales person is managed.

In addition, a system has been proposed in which a call is received from the customer and is registered in a service value-added network (VAN), and an arrangement mail is transmitted to a customer engineer (CE) through a personal handy phone system (PHS). In this system, the CE that has received the arrangement mail sends back a correspondence confirmation mail to the call center, and transmits an arrival confirmation mail to the call center when the CE arrives at the customer's location. In the call center, that information is input to the service VAN, and work time management is performed. The CE creates and prints a maintenance report, inputs information on the date and time of the completion to the service VAN through a mobile PC, and completion of the work is confirmed at the call center.

In addition, a technology has been proposed in which a work time by the worker and a standard work time are compared with each other for evaluation and management of the skill of a worker.

Japanese Laid-open Patent Publication No. 2004-139587, Japanese Laid-open Patent Publication No. 2002-132993, Japanese Laid-open Patent Publication No. 2005-293099, and Japanese Laid-open Patent Publication No. 2008-70643 are the related art.

### SUMMARY

According to an aspect of the invention, an apparatus receives, from a terminal, terminal location information indicating a location of the terminal carried by a worker, work-start information indicating a start of work designated by a work instruction for instructing the worker to perform work, and work-end information indicating an end of work designated by the work instruction. The apparatus transmits a control signal for causing the terminal to enter a state in which work-start information indicating a start of work designated by the work instruction is transmittable, based on a result of comparison between the terminal location information and work-instruction location information indicating a location at which work designated by the work instruction is to be performed by the worker. The apparatus compares standard work information indicating a standard for the worker to perform work designated by the work instruction, with actual work information that is calculated based on the received work-start information and the received work-end information, and outputs information on a result of the comparing.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an example of a configuration of a work management system, according to an embodiment;

FIG. 2 is a diagram illustrating an example of a functional configuration of a worker terminal, according to an embodiment;

FIG. 3 is a diagram illustrating an example of a functional configuration of a work management server, according to an embodiment;

FIG. 4 is a diagram illustrating an example of a work management database (DB), according to an embodiment;

FIG. 5 is a diagram illustrating an example of a user DB, according to an embodiment;

FIG. 6 is a diagram illustrating an example of a standard work time DB, according to an embodiment;

FIG. 7 is a diagram illustrating an example of a work history DB, according to an embodiment;

FIG. 8 is a diagram illustrating an example of a worker skill DB, according to an embodiment;

FIG. 9 is a diagram illustrating an example of a configuration of a computer that functions as a work management server, according to an embodiment;

FIG. 10 is a diagram illustrating an example of a configuration of a computer that functions as a worker terminal, according to an embodiment;

FIG. 11 is a diagram illustrating an example of an operational sequence for exchange of pieces of information between devices, according to an embodiment;

FIG. 12 is a diagram illustrating an example of an operational flowchart for work management processing, according to an embodiment;

FIG. 13 is a diagram illustrating an example of information recording in a work management DB, according to an embodiment;

FIG. 14 is a diagram illustrating an example of an operational flowchart for record processing, according to an embodiment;

FIG. 15 is a diagram illustrating an example of an operational flowchart for comparison output processing, according to an embodiment;

FIG. 16 is a diagram illustrating an example of recording of pieces of information in a work history DB, according to an embodiment;

FIG. 17 is a diagram illustrating an example of recording of pieces of information in a worker skill DB, according to an embodiment; and

FIG. 18 is a diagram illustrating an example of an operational flowchart for worker terminal processing, according to an embodiment.

### DESCRIPTION OF EMBODIMENTS

There is a case in which it is desirable that a work situation of a worker is grasped appropriately when, for work such as onsite maintenance, high service quality is desired or cost corresponding to a work time of the work is set. However, for example, in the related arts, a work situation may not be grasped appropriately based on result management in accordance with action schedule, or based on confirmation of a work time by self-report of the worker through a mail or the like.

It is desirable to output information corresponding to a comparison between information on a work corresponding to a worker and information on an actual work.

Examples of embodiments of the technology discussed herein are described below in detail with reference to drawings.

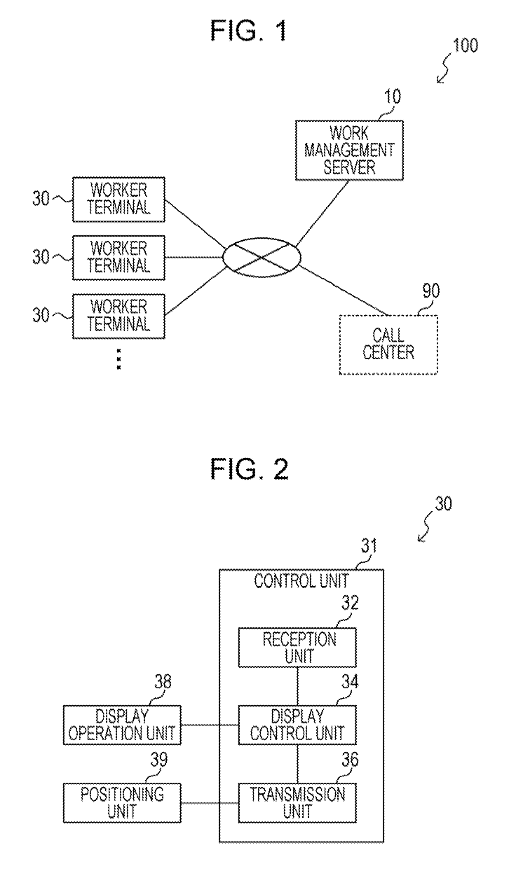

As illustrated in FIG. 1, a work management system 100 according to an embodiment includes a work management server 10 and a plurality of worker terminals 30. The work management server 10 is coupled to each of the worker terminals 30 through a network such as the Internet. In addition, an information processing device such as a server provided in a call center 90 (hereinafter simply referred to as a call center 90) is also coupled to the network. The number of worker terminals 30 is not limited to the example of FIG. 1.

The worker terminal 30 is carried by a worker who performs onsite maintenance or the like, and is an information processing terminal in which an application provided by the work management system 100 operates. The worker terminal 30 may be achieved, for example, by a laptop-type personal computer, a tablet terminal, a smartphone, or the like.

As illustrated in FIG. 2, the worker terminal 30 includes a control unit 31, a display operation unit 38 used to perform display and input of various pieces of information, and a positioning unit 39 that obtains location information on the worker terminal 30. The display operation unit 38 may be, for example, a touch panel display. The positioning unit 39 may be realized, for example, by a global positioning system (GPS).

Functionally, the control unit 31 includes a reception unit 32, a display control unit 34, and a transmission unit 36.

The reception unit 32 receives screen control information used to control display of various screens used for an application provided by the work management system 100 and acceptance of input to each of the screens, from the work management server 10, and transfers the received screen control information to the display control unit 34.

The display control unit 34 performs display control of a screen on the display operation unit 38, based on the screen control information transferred from the reception unit 32. In addition, the display control unit 34 accepts information input from the worker through the display operation unit 38, and performs display control of the screen on the display operation unit 38, based on the accepted information. In addition, the display control unit 34 transfers, to the transmission unit 36, information desired to be transmitted to the work management server 10 from among the pieces of accepted information.

The transmission unit 36 obtains location information on the worker terminal 30, which is obtained by the positioning unit 39 at specific time intervals, and transmits the location information to the work management server 10.

In addition, when start of work is input from the worker through the display operation unit 38, the transmission unit 36 transmits work start information to the work management server 10. The transmission unit 36 causes the work start information to include a work start time at which the start of the work has been input, a work start location indicating location information on the worker terminal 30 at the work start time, and information on a work instruction. Similarly, when end of the work is input from the worker through the display operation unit 38, the transmission unit 36 transmits work end information to the work management server 10. The transmission unit 36 causes the work end information to include a work end time at which the end of the work has been input, a work end location indicating location information on the worker terminal 30 at the work end time, and the information on the work instruction. The information on the work instruction is included in each of the work start information and the work end information in order to identify what work instruction is related to the work start information or the work end information.

In addition, the transmission unit 36 transmits the information transferred from the display control unit 34 to the work management server 10, as information desired to be transmitted to the work management server 10.

The work management server 10 is an information processing device that manages a work situation of a worker who carries the worker terminal 30 in accordance with a work instruction (described later in detail), and for example, may be achieved by a server device, a personal computer, or the like. The work management server 10 may be provided in the call center 90, or may be provided in a location other than the call center 90.

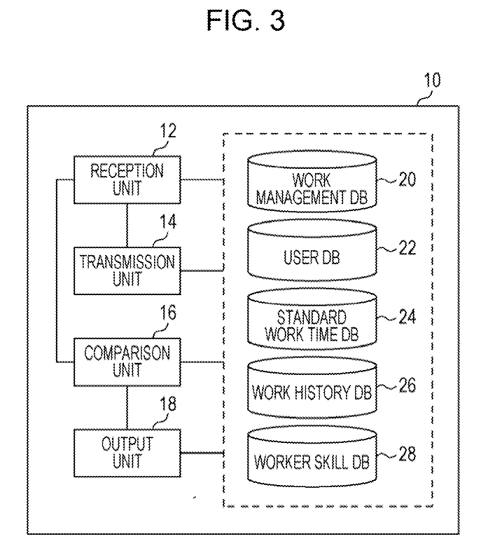

As illustrated in FIG. 3, functionally, the work management server 10 includes a reception unit 12, a transmission unit 14, a comparison unit 16, and an output unit 18. In addition, in a specific storage area of the work management server 10, stored are a work management database (DB) 20, a user DB 22, a standard work time DB 24, a work history DB 26, and a worker skill DB 28.

The reception unit 12 accepts information input by an administrator or the like of the work management system 100, for example, based on a work request from the call center 90. The information accepted herein includes, for example, identification information on a user at a worksite, identification information on a work content, and identification information on a worker who performs work. The reception unit 12 records a work instruction based on the accepted information, in the work management DB 20.

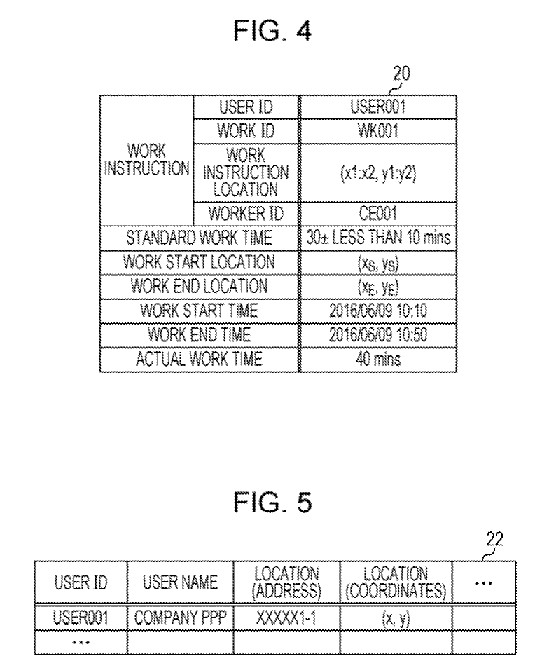

In FIG. 4, an example of the work management DB 20 is illustrated. In the example of FIG. 4, in the work management DB 20, as items of the work instruction, “user ID”, “work ID”, “work instruction location”, and “worker ID” are included. Here, “user ID” is an example of the identification information on a user, and “worker ID” is an example of identification information on a worker.

The reception unit 12 records information on “work instruction location” of the work management DB 20, for example, with reference to information stored in the user DB 22 as illustrated in FIG. 5. In the user DB 22 of FIG. 5, for each user, pieces of information such as “user ID”, “user name”, “location (address)”, and “location (coordinates)” are stored. Here, “location (coordinates)” is information obtained by representing coordinates of a location of a building or the like at which a work target device owned by the user is located, for example, by latitude and longitude.

More specifically, the reception unit 12 obtains “location (coordinates)” corresponding to an accepted user ID from the user DB 22, and records the obtained “location (coordinates)” in the work management DB 20 as “work instruction location”. Instead, as illustrated in FIG. 4, the reception unit 12 may record a specific range including the obtained “location (coordinates)” in the work management DB 20 as “work instruction location”. In addition, when a single user owns a plurality of work target devices, information on “location (coordinates)” is stored in the user DB 22 for the location at which each of the work target devices is installed. Then, it is only sufficient for the reception unit 12 to accept identification information on the work target device in addition to the user ID, and record in the item of “work instruction location” of the work management DB 20, based on “location (coordinates)” of the corresponding work target device. Here, recording of “work instruction location” included in the work instruction of the work management DB 20 is not limited to recording based on the information in the user DB 22 as descried above, and for example, may be direct recording of information input by the administrator or the like.

Items of “standard work time”, “work start location”, “work end location”, “work start time”, “work end time”, and “actual work time” are included in the work management DB 20, in addition to the items of the work instruction. At a time point at which the reception unit 12 has recorded the work instruction in the work management DB 20, the fields of these items are blank. The details of the items of “standard work time”, “work start location”, “work end location”, “work start time”, “work end time”, and “actual work time” are described later.

In addition, the reception unit 12 receives various pieces of information such as location information, work start information, work end information, a movement reason, a deviation reason of the worker terminal 30, which are transmitted from the worker terminal 30. The reception unit 12 sends the received location information to the transmission unit 14 and the comparison unit 16, and sends the received work start information and work end information to the comparison unit 16. In addition, the reception unit 12 records the received movement reason or deviation reason in the work history DB 26 described later.

The transmission unit 14 transmits pieces of screen control information of various screens to the worker terminal 30. In addition, the transmission unit 14 transmits the information on the work instruction, which has been recorded in the work management DB 20 by the reception unit 12, to the worker terminal 30 carried by a worker indicated by the worker ID included in the work instruction.

In addition, the transmission unit 14 transmits, to the worker terminal 30, a signal that performs control so that the work start information corresponding to the work instruction is allowed to be transmitted from the worker terminal 30, based on a result of comparison between the location information on the worker terminal 30, which has been received from the reception unit 12, and “work instruction location” included in the work instruction.

For example, when a distance between the location of the worker terminal 30 and the work instruction location is a specific distance or less, the transmission unit 14 transmits, to the worker terminal 30, screen control information used to display a work start button used to instruct start of the work on the worker terminal 30. As the specific distance, a distance is defined by which it is determined that the worker has arrived at the work instruction location. Instead, the transmission unit 14 may transmit, to the worker terminal 30, screen control information used to change the work start button displayed on the worker terminal 30 from an inactive state (the selection is not allowed) to an active state (the selection is allowed).

As described above, input of work start is not allowed unless the worker arrives at the work instruction location, so that it may be confirmed that the worker has actually visited the work instruction location.

In addition, the transmission unit 14 transmits, to the worker terminal 30, a signal that performs control so that work end information is allowed to be transmitted, for example, at specific timing such as timing after the work start information is transmitted from the worker terminal 30. For example, in a manner similar to the above-described work start button, the transmission unit 14 transmits, to the worker terminal 30, screen control information used to display a work end button or to change the work end button being displayed from an inactive state to an active state.

The comparison unit 16 compares standard work information corresponding to the work instruction and the worker with actual work information calculated based on the work start information and the work end information that have been received from the reception unit 12. The standard work information includes a reference value of a distance of movement between the work start location and the work end location, and information on a standard work time for each work. The actual work information includes a distance of movement between the work start location and the work end location, and the actual work time. The comparison unit 16 compares the reference value of the distance of movement with the actual distance of movement, and compares the standard work time with the actual work time.

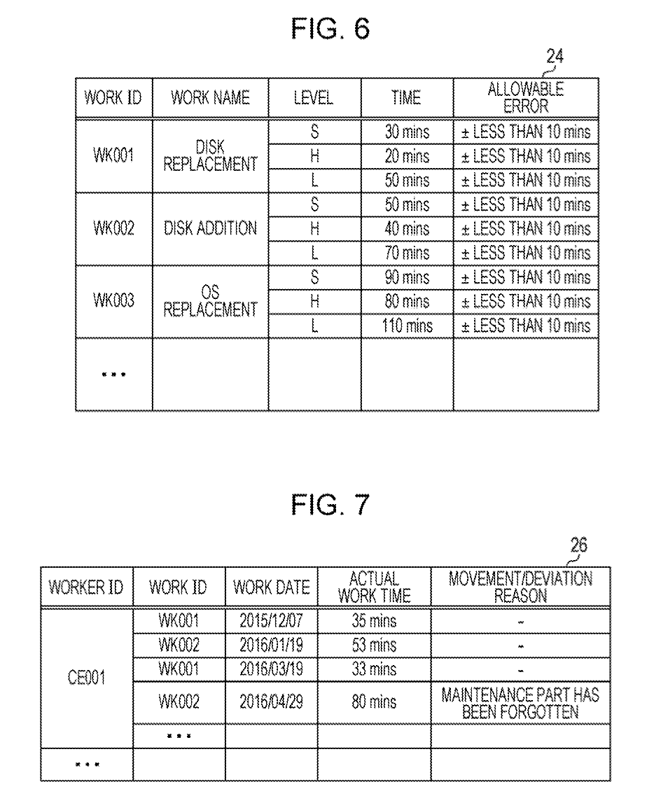

More specifically, the comparison unit 16 obtains a standard work time when the worker indicted by the worker ID included in the work instruction stored in the work management DB 20 performs the work indicated by the work ID included in the work instruction. For example, the comparison unit 16 obtains a corresponding standard work time and an allowable error from the standard work time DB 24 as illustrated in FIG. 6.

In the standard work time DB 24 of FIG. 6, a work ID and a work name are stored in association with each other for each of the works, and a standard work time and an allowable error for a level of each of the workers are stored for each work. The level indicates a skill degree of the worker, and in FIG. 6, an example using levels at three stages such as “standard (S)”, “high (H)”, and “low (L)” is illustrated. The allowable error is a value used as a margin when a standard work time and an actual work time are compared with each other. The level sorting, and the standard work time and the allowable error for each of the levels illustrated in FIG. 6 are examples, and the embodiment is not limited to such an example.

In addition, in order not to present the information on the standard work time to the worker, the standard work time DB 24 is set so that an access from the worker terminal 30 is inhibited. As a result, unauthorized intentional adjustment of a work time by the worker who operates for the standard work time may be avoided.

More specifically, the comparison unit 16 obtains the level corresponding to the work ID and the worker ID included in the work instruction from the worker skill DB 28 described later. In addition, the comparison unit 16 obtains the standard work time and the allowable error that correspond to the work ID included in the work instruction and the obtained level, from the standard work time DB 24, and records the obtained standard work time and allowable error in the item of “standard work time” of the work management DB 20.

In addition, the comparison unit 16 records the information included in the work start information in the items of “work start location” and “work start time” of the work management DB 20, and records the information included in the work end information in the items of “work end location” and “work end time” of the work management DB 20. In addition, the comparison unit 16 calculates a difference between the work start time and the work end time as an actual work time, and records the difference in “actual work time” of the work management DB 20.

The comparison unit 16 calculates a distance between the work start location and the work end location that have been recorded in the work management DB 20, and compares the calculated distance of movement with a reference value. The reference value of the distance of movement is defined in advance based on a normal distance of movement assumed in the work indicated by the work instruction. The comparison unit 16 notifies the output unit 18 of the result of comparison between the calculated distance of movement and the reference value together with the information on the work instruction.

In addition, when the calculated distance of movement is the reference value or less, the comparison unit 16 compares the actual work time with the standard work time and the allowable error, which are recorded in the work management DB 20. The comparison unit 16 notifies the output unit 18 of the result of comparison between the actual work time and the standard work time, together with the information on the work instruction, the work date, and the actual work time. As described above, due to the comparison between the actual work time and the standard work time when the distance of movement is the reference value or less, the comparison between the actual work time and the standard work time may be performed using an appropriate work not including unnecessary movement and the like as a target.

In addition, the comparison unit 16 compares the location information on the worker terminal 30, which is received from the reception unit 12, with the work instruction location stored in the work management DB 20 until the work end information is received after the work start information is received from the reception unit 12, that is, during the work. The comparison unit 16 notifies the output unit 18 of the comparison result of the location information during the work.

When the comparison unit 16 notifies the output unit 18 of the information on the work instruction, the work date, and the actual work time, the output unit 18 records the notified information in the work history DB 26. In FIG. 7, an example of the work history DB 26 is illustrated. In the example of FIG. 7, a work history including “work ID”, “work date”, and “actual work time” is recorded in association with “worker ID” for each of the workers. In addition, the work history DB 26 includes an item of “movement/deviation reason” in which a movement reason or a deviation reason is recorded by the reception unit 12.

When the work history is recorded in the work history DB 26, the output unit 18 calculates an average work time for the worker ID and the work ID using the recorded work history and the actual work time of a work history having the same worker ID and work ID. In addition, the output unit 18 respectively updates an average work time and a level for the corresponding worker ID and work ID stored in the worker skill DB 28 into the calculated value and a level corresponding to the value.

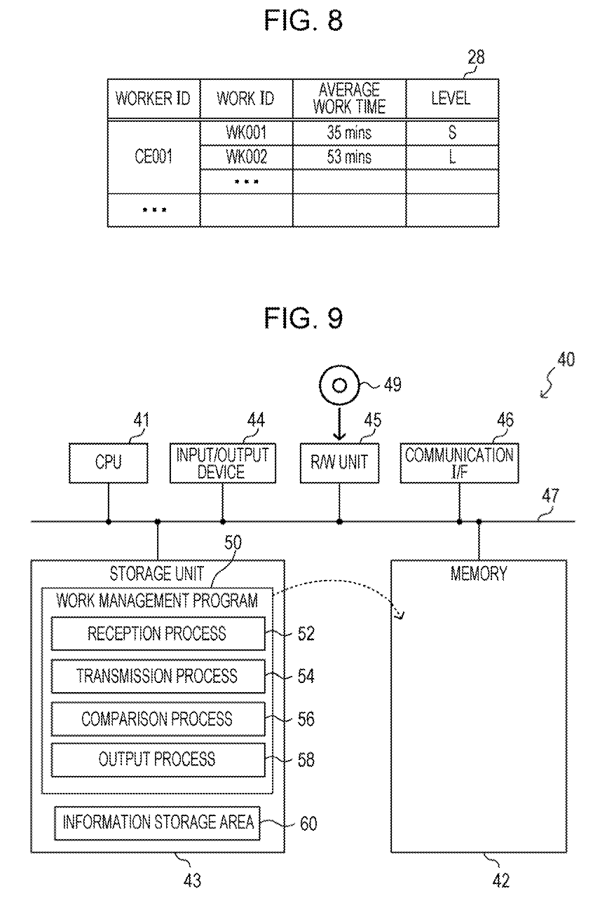

In FIG. 8, an example of the worker skill DB 28 is illustrated. In the example of FIG. 8, “work ID”, “average work time”, and “level” are recorded in association with “worker ID” for each of the workers.

When records of an average work time and a level corresponding to the corresponding worker ID and work ID do not exist in the worker skill DB 28, the output unit 18 adds the calculated average work time and the corresponding level to the worker skill DB 28 as new records. The output unit 18 records a level corresponding to the standard work time closest to the calculated average work time from among “standard work times” associated with the corresponding work ID in the standard work time DB 24, in the item of “level”.

In addition, when the comparison result notified from the comparison unit 16 indicates that the distance of movement from the work start location to the work end location exceeds the reference value, the output unit 18 outputs screen control information of a screen used to inquire about a reason of movement from the work instruction location (hereinafter referred to as “movement reason”). In the worker terminal 30, based on the screen control information, the inquiry screen for the movement reason is displayed on the display operation unit 38, and a movement reason is input by the worker. The input movement reason is received at the above-described reception unit 12, and recorded in the field of “movement/deviation reason” of the work history DB 26.

In addition, when the comparison result notified from the comparison unit 16 indicates that the actual work time exceeds a range of the standard work time, the output unit 18 outputs screen control information of a screen used to inquire about a reason of a deviation of actual work time from the standard work time (hereinafter referred to as “deviation reason”). In the worker terminal 30, based on the screen control information, the inquiry screen for the deviation reason is displayed on the display operation unit 38, and a deviation reason is input by the worker. The input deviation reason is received at the above-described reception unit 12 and recorded in the field of “movement/deviation reason” of the work history DB 26. The range of the standard work time is a range obtained by incorporating an allowable error into a standard work time.

In addition, when the comparison result notified from the comparison unit 16 indicates that the location of the worker terminal 30 during the work exceeds a specific distance from the work instruction location, the output unit 18 outputs an alert to the worker terminal 30. The output of the alert may be performed through display of an alert message using a text, or through output of an alert sound or an audio message.

In addition, when a movement reason or a deviation reason is recorded in the work history DB 26, the output unit 18 notifies the call center 90 of the recorded movement reason or deviation reason with the information on the work instruction.

The work management server 10 may be realized, for example, by a computer 40 illustrated in FIG. 9. The computer 40 includes a central processing unit (CPU) 41, a memory 42 as a temporary storage area, and a nonvolatile storage unit 43. In addition, the computer 40 includes an input/output device 44, a read/write (R/W) unit 45 that controls reading and writing of data for a storage medium 49, and a communication interface (I/F) 46 coupled to a network such as the Internet. The CPU 41, the memory 42, the storage unit 43, the input/output device 44, the R/W unit 45, and the communication I/F 46 are coupled to each other through a bus 47.

The storage unit 43 may be realized by a hard disk drive (HDD), a solid state drive (SSD), a flash memory, or the like. In the storage unit 43 as a storage medium, a work management program 50 used to cause the computer 40 to function as the work management server 10 is stored. The work management program 50 includes a reception process 52, a transmission process 54, a comparison process 56, and an output process 58. In addition, the storage unit 43 includes an information storage area 60 in which pieces of information that constitute the work management DB 20, the user DB 22, the standard work time DB 24, the work history DB 26, and the worker skill DB 28 are stored.

The CPU 41 reads the work management program 50 from the storage unit 43, deploys the work management program 50 to the memory 42, and sequentially executes the processes included in the work management program 50. The CPU 41 operates as the reception unit 12 illustrated in FIG. 3 by executing the reception process 52. In addition, the CPU 41 operates as the transmission unit 14 illustrated in FIG. 3 by executing the transmission process 54. In addition, the CPU 41 operates as the comparison unit 16 illustrated in FIG. 3 by executing the comparison process 56. In addition, the CPU 41 operates as the output unit 18 illustrated in FIG. 3 by executing the output process 58. In addition, the CPU 41 reads information from the information storage area 60, and deploys the work management DB 20, the user DB 22, the standard work time DB 24, the work history DB 26, and the worker skill DB 28 to the memory 42. As a result, the computer 40 that has executed the work management program 50 functions as the work management server 10.

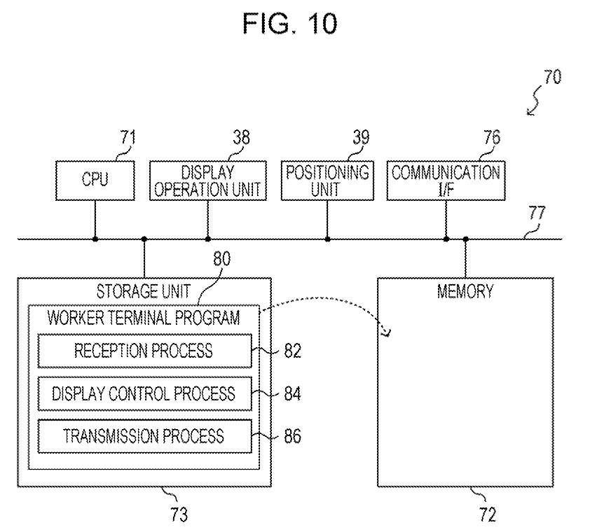

The worker terminal 30 may be realized, for example, by a computer 70 illustrated in FIG. 10. The computer 70 includes a CPU 71, a memory 72 as a temporary storage area, and a nonvolatile storage unit 73. In addition, the computer 70 includes the display operation unit 38, the positioning unit 39, and a communication I/F 76. The CPU 71, the memory 72, the storage unit 73, the display operation unit 38, the positioning unit 39, and the communication I/F 76 are coupled to each other through a bus 77.

The storage unit 73 is achieved by an HDD, an SSD, a flash memory, or the like. In the storage unit 73 as a storage medium, a worker terminal program 80 that causes the computer 70 to function as the worker terminal 30 is stored. The worker terminal program 80 includes a reception process 82, a display control process 84, and a transmission process 86.

The CPU 71 reads the worker terminal program 80 from the storage unit 73, deploys the worker terminal program 80 to the memory 72, and sequentially executes the processes included in the worker terminal program 80. The CPU 71 operates as the reception unit 32 illustrated in FIG. 2 by executing the reception process 82. In addition, the CPU 71 operates as the display control unit 34 illustrated in FIG. 2 by executing the display control process 84. In addition, the CPU 71 operates as the transmission unit 36 illustrated in FIG. 2 by executing the transmission process 86. As a result, the computer 70 that has executed the worker terminal program 80 functions as the worker terminal 30.

The functions realized by the work management program 50 and the worker terminal program 80 may be realized, for example, by a semiconductor integrated circuit, and more specifically, an application specific integrated circuit (ASIC) or the like.

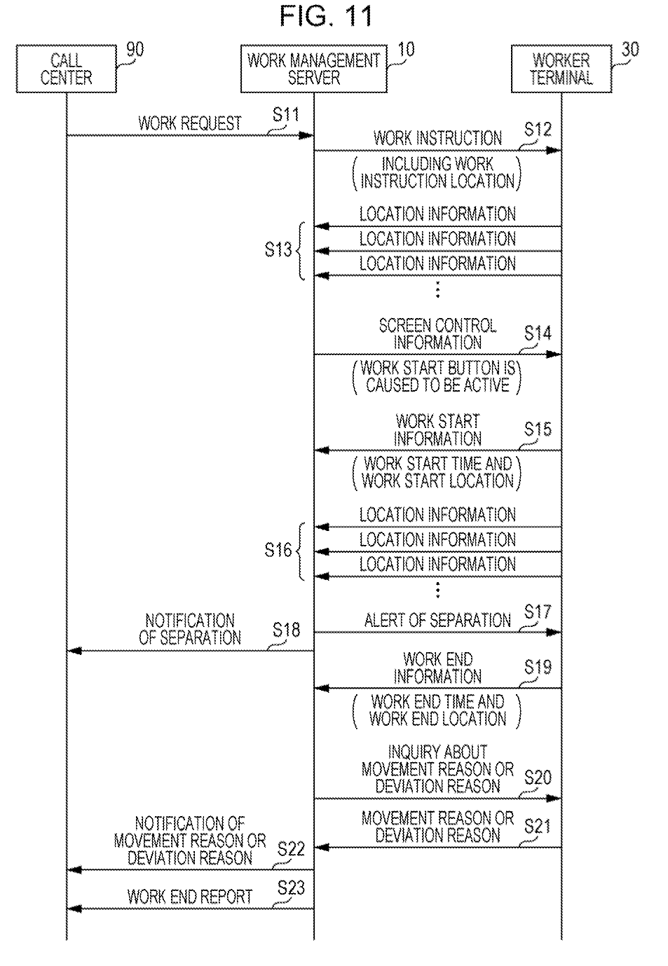

An operation of the work management system 100 according to the embodiment is described below. First, with reference to the sequence diagram in FIG. 11, exchange of pieces of information between the devices is described below.

When the work management server 10 accepts a work request from the call center 90 (S11), a work instruction including a work instruction location is transmitted from the work management server 10 to a corresponding worker terminal 30 (S12).

A worker who has accepted the work instruction goes to the work instruction location with the worker terminal 30. During the time, location information on the worker terminal 30 is transmitted from the worker terminal 30 to the work management server 10 at specific time intervals (S13).

When the worker who carries the worker terminal 30 arrives in the vicinity of the work instruction location, the work management server 10 transmits screen control information used to make a work start button active, to the worker terminal 30 (S14).

Then, when the worker presses the work start button displayed on the worker terminal 30, work start information including pieces of information on a work start time and a work start location is transmitted from the worker terminal 30 to the work management server 10 (S15).

In addition, until a work end button is selected in the worker terminal 30, location information on the worker terminal 30 is transmitted from the worker terminal 30 to the work management server 10 at the specific time intervals (S16).

The work management server 10 determines whether the worker during the work has left the work instruction location (the worker has been away from the work instruction location by a specific distance or more) by comparing the received location information with the work instruction location of the work instruction. When the worker leaves the work instruction location, the work management server 10 outputs an alert to the worker terminal 30 (S17), and notifies the call center 90 of information indicating that the worker has left the work instruction location, together with the corresponding information on the work instruction (S18).

When the work ends, the worker presses the work end button displayed on the worker terminal 30. As a result, work end information including pieces of information on a work end time and a work end location is transmitted from the worker terminal 30 to the work management server 10 (S19).

In the work management server 10, the comparison of a distance of movement from the work start location to the work end location with the reference value, and the comparison of the actual work time with the standard work time are performed. When the distance of movement exceeds the reference value, an inquiry about a movement reason is transmitted from the work management server 10 to the worker terminal 30, and when the actual work time deviates from the standard work time, an inquiry about a deviation reason is transmitted from the work management server 10 to the worker terminal 30 (S20).

The worker inputs a movement reason or a deviation reason to the inquiry screen which is displayed on the worker terminal 30 therefor. The input movement reason or deviation reason is transmitted to the work management server 10 (S21) and recorded in the work management server 10, and the call center 90 is notified of the input reason (S22).

In addition, in the work management server 10, recording of a work history, update of an average work time, and the like, are performed, and the end of the work is reported from the work management server 10 to the call center 90 (S23).

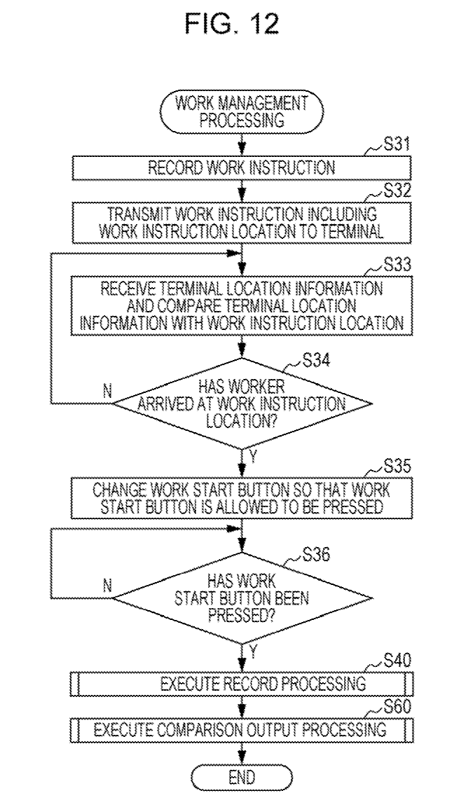

Work management processing executed in the work management server 10 and worker terminal processing executed in the worker terminal 30 are described below. For example, when pieces of information such as a user ID, a work ID, and a worker ID are input to the work management server 10 by the administrator or the like of the work management system 100, based on the work request from the call center 90, the work management processing illustrated in FIG. 12 is executed in the work management server 10. In addition, in the worker terminal 30 that has received the work instruction, when an application provided by the work management system 100 starts, the worker terminal processing illustrated in FIG. 18 is executed in the worker terminal 30.

First, the work management processing executed in the work management server 10 is described.

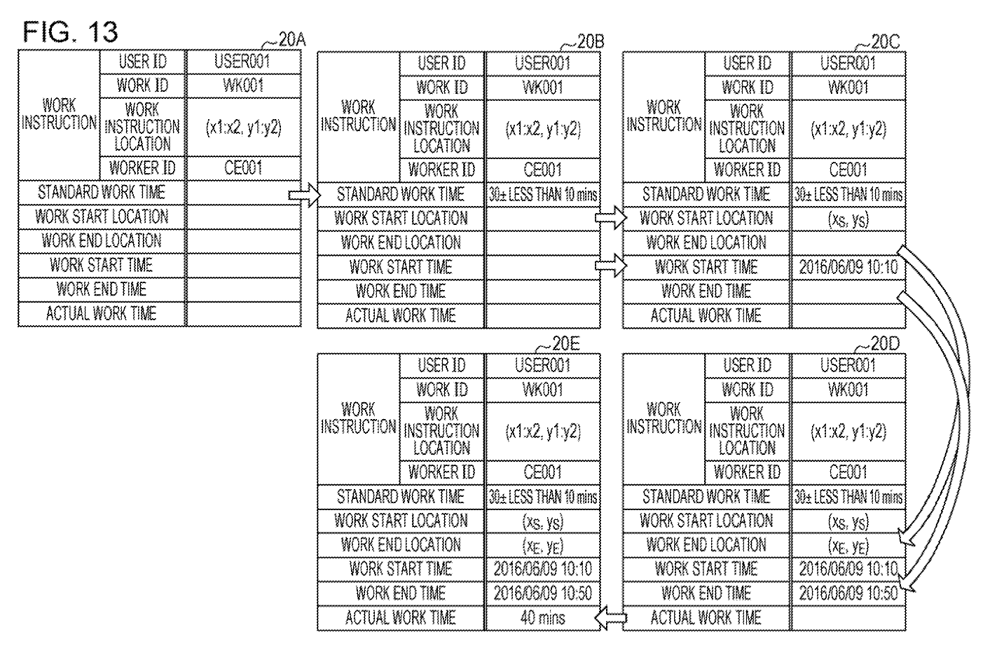

In Step S31 of FIG. 12, the reception unit 12 records information of the work instruction, based on the pieces of information input by the administrator or the like and the information in the user DB 22, for example, as illustrated in the work management DB 20A of FIG. 13. Next, in Step S32, the transmission unit 14 transmits the information on the work instruction recorded in the work management DB 20 by the reception unit 12, to a worker terminal 30 carried by a worker indicated by a work ID included in the work instruction.

Next, in Step S33, the reception unit 12 receives location information on the worker terminal 30, which has been transmitted from the worker terminal 30, and sends the received location information to the transmission unit 14. The transmission unit 14 compares the location of the worker terminal 30 with the work instruction location stored in the work management DB 20.

Next, in Step S34, the transmission unit 14 determines whether the worker has arrived at the work instruction location by determining whether a distance between the location of the worker terminal 30 and the work instruction location is a specific distance or less. When the worker is yet to arrive at the work instruction location, the flow returns to Step S33, and when the worker arrives at the work instruction location, the flow proceeds to Step S35.

In Step S35, the transmission unit 14 transmits, to the worker terminal 30, screen control information used to display the work start button on the worker terminal 30. Alternatively, the transmission unit 14 transmits, to the worker terminal 30, screen control information used to change the work start button being displayed from an inactive state (the selection is not allowed) to an active state (the selection is allowed). As a result, in the worker terminal 30, the work start button is allowed to be pressed by the worker.

Next, in Step S36, the reception unit 12 determines whether the work start button has been pressed by the worker in the worker terminal 30 by determining whether the work start information has been received from the worker terminal 30. When the work start button is not pressed, the determination in Step S36 is repeated, and when the work start button is pressed, the flow proceeds to Step S40.

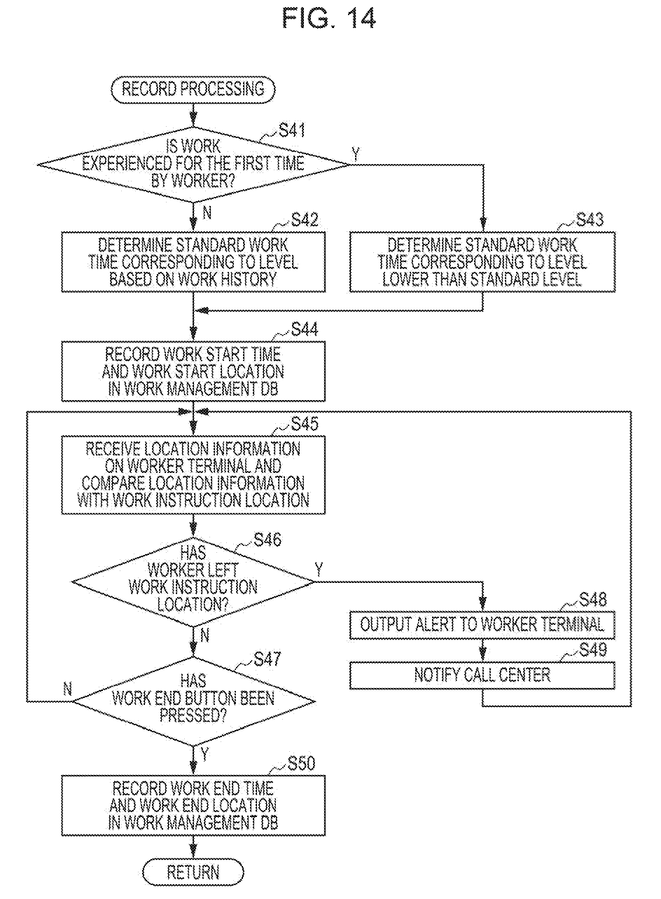

In Step S40, record processing illustrated in FIG. 14 is executed. In Step S41, when the work start information is sent from the reception unit 12 to the comparison unit 16, the comparison unit 16 determines whether work corresponding to the work instruction is experienced for the first time by the worker. Such determination may be performed, for example, depending on whether a work history corresponding to a worker ID and a work ID identified by information on the work instruction included in the work start information exists in the work history DB 26. When the work has been experienced by the worker, the flow proceeds to Step S42, and when the work is experienced for the first time by the worker, the flow proceeds to Step S43.

In Step S42, the comparison unit 16 obtains a level for the corresponding worker ID and work ID from the worker skill DB 28. In addition, the comparison unit 16 obtains a standard work time and an allowable error corresponding to the worker ID, the work ID, and the level from the standard work time DB 24. As illustrated in the work management DB 20B of FIG. 13, the comparison unit 16 records the standard work time and the allowable error in the item of “standard work time”. In the item of “standard work time” illustrated in FIG. 13, an example of record of information in a format of “standard work time±less than allowable error” is illustrated. Here, “30±less than 10 mins” of FIG. 13 indicates that the actual work time is determined to be within a standard work time when the actual work time is more than 20 mins and less than 40 mins.

On the other hand, in Step S43, the comparison unit 16 obtains a standard work time and an allowable error for the corresponding work ID and a level lower than a standard level, from the standard work time DB 24. In the example of the standard work time DB 24 illustrated in FIG. 6, the comparison unit 16 obtains a standard work time and an allowable error corresponding to a level of “low (L)” that is lower than a level of “standard (S)”. The comparison unit 16 records the obtained information in the item of “standard work time”, as illustrated in the work management DB 20B of FIG. 13.

Next, in Step S44, the comparison unit 16 respectively records the pieces of information on the work start time and the work start location included in the work start information transferred from the reception unit 12, in the items of “work start time” and “work start location”, as illustrated in the work management DB 20C of FIG. 13.

Next, in Step S45, the reception unit 12 receives the location information on the worker terminal 30, which has been transmitted from the worker terminal 30, and sends the location information to the comparison unit 16. The comparison unit 16 compares the location information on the worker terminal 30, which has been received from the reception unit 12, with the work instruction location stored in the work management DB 20, and notifies the output unit 18 of the comparison result.

Next, in Step S46, the output unit 18 determines whether the worker has left the work instruction location. The determination may be performed by determining whether the comparison result notified from the comparison unit 16 indicates that the location of the worker terminal 30 during the work deviates from the work instruction location by the specific distance. When the worker does not leave the work instruction location, the flow proceeds to Step S47, and the reception unit 12 determines whether the work end button has been pressed by the worker in the worker terminal 30 by determining whether work end information has been received from the worker terminal 30. When the work end button is not pressed, the flow returns to Step S45, and when the work end button is pressed, the flow proceeds to Step S50.

On the other hand, in Step S46, when it is determined that the worker has left the work instruction location, the flow proceeds to Step S48, and the output unit 18 outputs an alert to the worker terminal 30. In addition, in the next Step S49, the call center 90 is notified of information indicating that the worker has left the work instruction location, and the flow returns to Step S45.

In Step S50, the reception unit 12 sends the received work end information to the comparison unit 16. In addition, as illustrated in the work management DB 20D of FIG. 13, the comparison unit 16 respectively records pieces of information on a work end time and a work end location included in the work end information received from the reception unit 12, in the items of “work end time” and “work end location”. Then, the record processing ends, and the flow returns to the work management processing illustrated in FIG. 12.

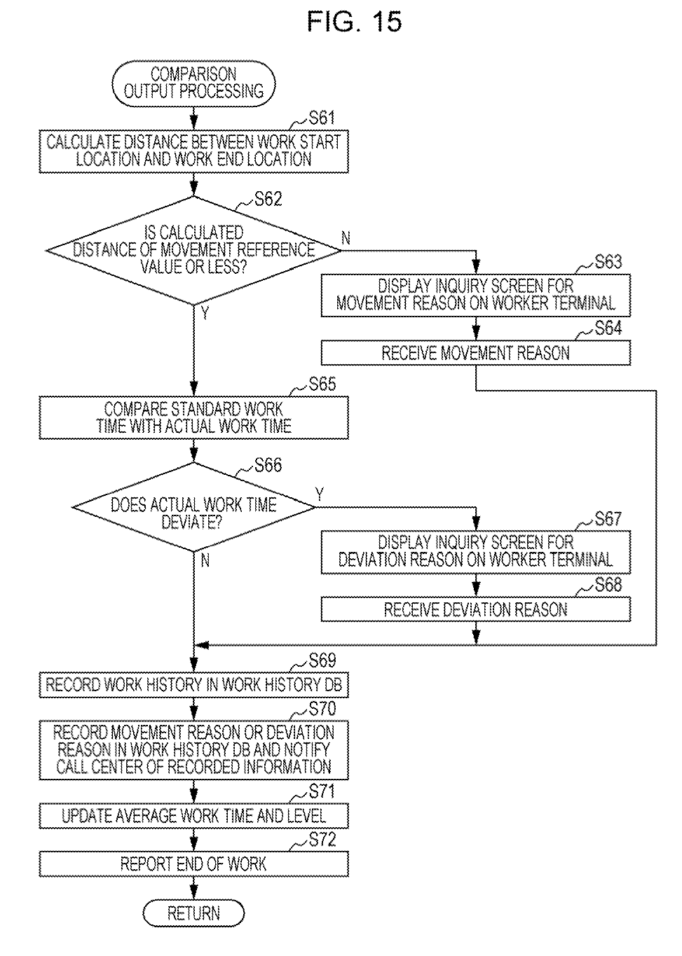

Next, in Step S60 of the work management processing of FIG. 12, comparison output processing illustrated in FIG. 15 is executed. In Step S61, the comparison unit 16 calculates a distance between the work start location and the work end location that have been recorded in the work management DB 20.

Next, in Step S62, the comparison unit 16 compares the calculated distance of movement with a reference value, which has been defined in advance. The comparison unit 16 notifies the output unit 18 of the result of comparison between the calculated distance of movement and the reference value. The output unit 18 determines whether the comparison result notified from the comparison unit 16 indicates that the distance of movement from the work start location to the work end location is the reference value or less. When the calculated distance of movement is the reference value or less, the flow proceeds to Step S65, and when the calculated distance of movement exceeds the reference value, the flow proceeds to Step S63.

In Step S63, the output unit 18 transmits screen control information of the inquiry screen for a movement reason to the worker terminal 30. In the worker terminal 30, based on the screen control information, the inquiry screen for a movement reason is displayed on the display operation unit 38, and a movement reason is input by the worker and transmitted to the work management server 10. In addition, in the next Step S64, the reception unit 12 receives the movement reason transmitted from the worker terminal 30, and the flow proceeds to Step S69.

In Step S65, the comparison unit 16 calculates a difference between the work start time and the work end time that have been recorded in the work management DB 20 as the actual work time. In addition, as illustrated in the work management DB 20E of FIG. 13, the comparison unit 16 records the calculated actual work time in the item of “actual work time”. In addition, the comparison unit 16 compares the actual work time with the standard work time and the allowable error, which have been recorded in the work management DB 20, and notifies the output unit 18 of the comparison result together with the information on the work instruction, the work date, and the actual work time.

Next, in Step S66, the output unit 18 determines whether the actual work time deviates from the standard work time by determining whether the comparison result notified from the comparison unit 16 indicates that the actual work time exceeds the standard work time into which the allowable error has been incorporated. When the actual work time deviates, the flow proceeds to Step S67, and when the actual work time does not deviate, the flow proceeds to Step S69.

In Step S67, the output unit 18 transmits screen control information of an inquiry screen for a deviation reason to the worker terminal 30. In the worker terminal 30, based on the screen control information, the inquiry screen for a deviation reason is displayed on the display operation unit 38, and a deviation reason is input by the worker and transmitted to the work management server 10. Then, in the next Step S68, the reception unit 12 receives the deviation reason transmitted from the worker terminal 30, and the flow proceeds to Step S69.

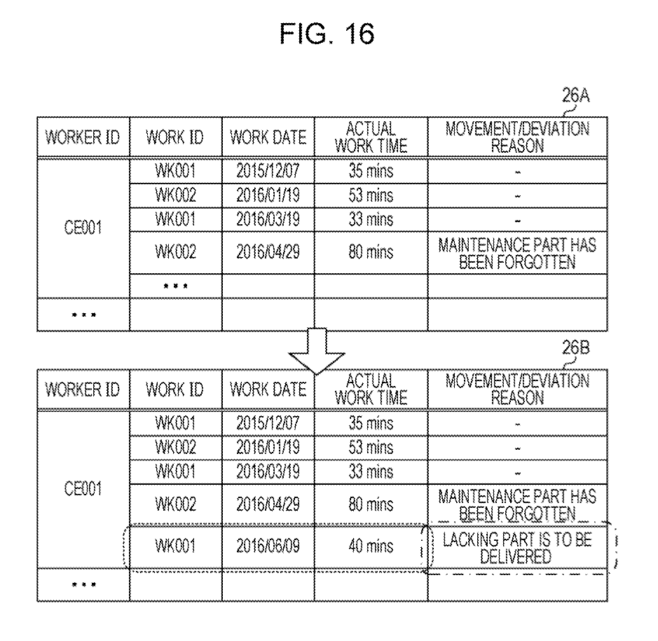

In Step S69, the output unit 18 records the information on the work instruction, the work date, and the actual work time that have been notified from the comparison unit 16 in the work history DB 26. For example, an example in which a work history has been newly recorded in the work history DB 26A in the state illustrated in the upper part of FIG. 16 is illustrated in the work history DB 26B in the lower part of FIG. 16 (broken line part in FIG. 16).

Next, in Step S70, when the reception unit 12 receives a movement reason or a deviation reason in the above-described Step S64 or Step S68, as illustrated in the lower part of FIG. 16, the reception unit 12 records a movement reason or a deviation reason in the work history DB 26B (dash-dotted line part in FIG. 16). In addition, the output unit 18 notifies the call center 90 of the recorded movement reason or deviation reason. When the flow does not pass through the above-described Steps S63 and S64 or Steps S67 and S68, the processing of the Step S70 is skipped.

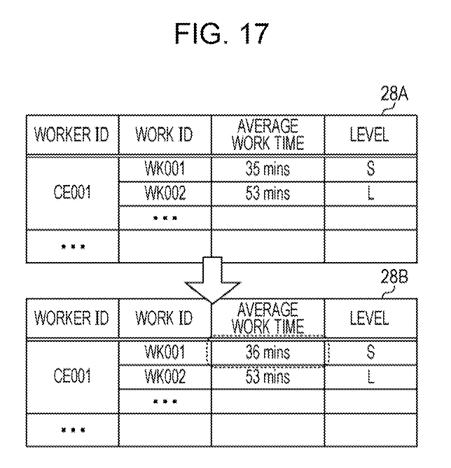

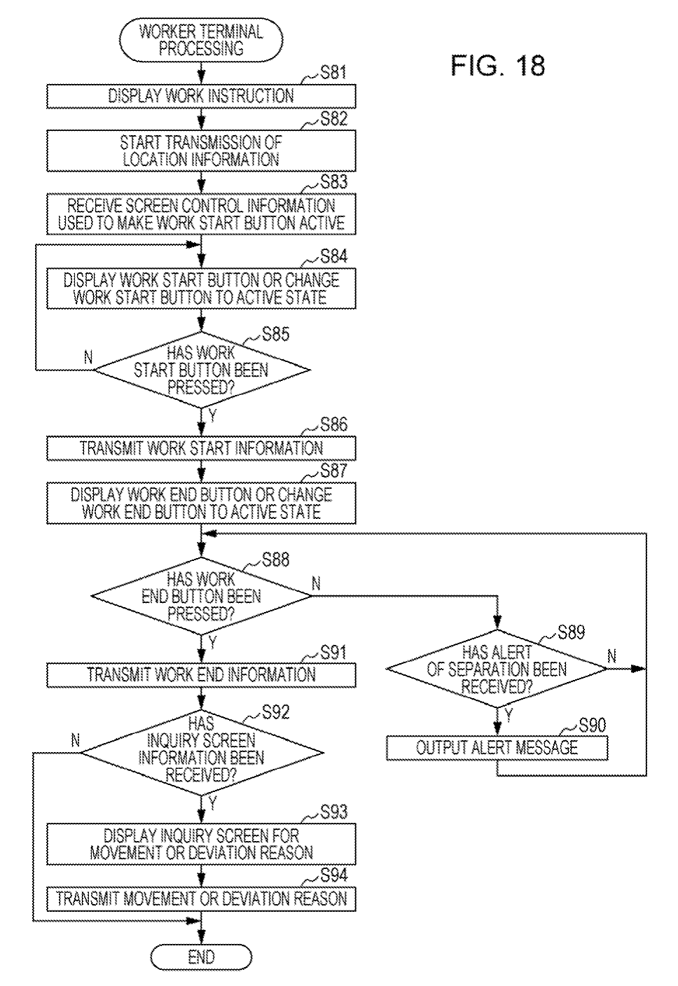

Next, in Step S71, using the actual work time of the work history recorded in the work history DB 26 and actual work times of work histories having the same worker ID and the work ID, the output unit 18 calculates an average work time for the worker ID and the work ID. In addition, the output unit 18 updates the average work time and the level for the corresponding worker ID and work ID stored in the worker skill DB 28 into the calculated value and the level corresponding to the value. For example, an example in which the worker skill DB 28A in the state illustrated in the upper part of FIG. 17 has been updated based on the new work history is illustrated in the worker skill DB 28B of the lower part of FIG. 17 (broken line part in FIG. 17). In this example, for example, when the standard work time DB 24 of FIG. 6 is used, there is no change in the level caused by update of the average work time, so that the level is not updated.

Next, in Step S72, the output unit 18 reports the end of the work to the call center 90, and the comparison output processing ends and the work management processing illustrated in FIG. 12 also ends.

When the flow passes though Steps S63 and S64, an actual work time is not calculated, so that the above-described processing of Steps S69 and S71 is skipped.

The worker terminal processing executed in the worker terminal 30 is described below.

In Step S81 of FIG. 18, the information on the work instruction, which has been received at the reception unit 32, is sent to the display control unit 34, and the display control unit 34 displays the work instruction on the display operation unit 38.

Next, in Step S82, the transmission unit 36 starts processing to obtain location information on the worker terminal 30 from the positioning unit 39 and transmit the location information to the work management server 10 at the specific time intervals.

Next, in Step S83, when the reception unit 32 receives screen control information used to make a work start button active, from the work management server 10, the reception unit 32 sends the screen control information to the display control unit 34.

Next, in Step S84, the display control unit 34 displays the work start button on the display operation unit 38, based on the screen control information received from the reception unit 32. Alternatively, the display control unit 34 changes the work start button being displayed from the inactive state to the active state.

Next, in Step S85, the display control unit 34 determines whether the work start button has been pressed. When the work start button is not pressed, the determination in Step 85 is repeated, and when the work start button is pressed, the flow proceeds to Step S86.

In Step S86, the transmission unit 36 obtains location information obtained when the work start button is pressed, from the positioning unit 39 and sets the location information as a work start location. Then, the transmission unit 36 transmits the work start information including the work start time and the work start location at which the work start button is pressed, to the work management server 10.

Next, in Step S87, the display control unit 34 displays the work end button, or changes the work end button being displayed from the inactive state to the active state.

Next, in Step S88, the display control unit 34 determines whether the work end button has been pressed. When the work end button is not pressed, the flow proceeds to Step S89, and when the work end button is pressed, the flow proceeds to Step S91.

In Step S89, the reception unit 32 determines whether an alert indicating that the worker has left the work instruction location is already received from the work management server 10. When the alert is already received, the flow proceeds to Step S90, and then the display control unit 34 displays an alert message of the deviation on the display operation unit 38, and the flow returns to Step S88. When the alert is not received, the flow returns to Step S88.

In Step S91, the transmission unit 36 obtains location information obtained when the work end button is pressed, from the positioning unit 39, and sets the location information as a work end location. Then, the transmission unit 36 transmits the work end information including the work end time and the work end location at which the work end button is pressed, to the work management server 10.

Next, in Step S92, the reception unit 32 determines whether screen control information of the inquiry screen for a movement reason or a deviation reason has been received from the work management server 10. When the screen control information of the inquiry screen is received, the flow proceeds to Step S93, and the reception unit 32 sends the screen control information to the display control unit 34. Then, the display control unit 34 displays the inquiry screen for the movement reason or the deviation reason on the display operation unit 38.

Next, in Step S94, in the inquiry screen for the movement reason or the deviation reason, when a movement reason or a deviation reason is input by the worker, the transmission unit 36 transmits the input movement reason or deviation reason to the work management server 10, and the worker terminal processing ends.

On the other hand, in the above-described Step S92, when the reception unit 32 determines that the screen control information of the inquiry screen for the movement reason or the deviation reason is not received, Steps S93 and S94 are skipped, and the worker terminal processing ends.

As described above, in the work management system according to the embodiment, when the worker terminal location and the work instruction location are compared with each other, and it is determined that the worker has arrived at the work instruction location, input of the work start from the worker terminal is allowed to be performed. Therefore, it may be confirmed that the worker has actually visited the work instruction location. In addition, the location at the time of the start of the work and the location at the time of the end of the work are compared with each other, and then the actual work time from the start to the end of the work is calculated, so that the actual work time and the standard work time is compared with each other by using an appropriate work not including unnecessary movement or the like from the work instruction location as a target. Thus, it may be appropriately estimated that whether the worker has complied with the work instruction.

In addition, when information on a standard work time is not presented to the worker, unauthorized intentional adjustment of a work time by the worker who operates for the standard work time may be avoided.

In the above-described embodiment, the case is described in which the worker terminal is controlled so that the worker terminal is allowed to transmit work end information at specific timing such as timing after transmission of work start information, but the embodiment is not limited to such a case. In a manner similar to the case in which the worker terminal is controlled so that the work start information is allowed to be transmitted, the worker terminal may be controlled so that the work end information is allowed to be transmitted when the worker terminal 30 exists within a specific distance from the work instruction location. In this case, when the worker leaves the work instruction location, the work end information is not allowed to be transmitted, so that the processing may be executed similar to the case in which “No” is determined in Step S62 of the comparison output processing illustrated in FIG. 15. In addition, it is also conceivable that the worker who has left the work instruction location once returns to the work instruction location and transmits the work end information. In this case, however, a probability in which the calculated actual work time exceeds the standard work time becomes high, thereby allowing the appropriateness of the work to be determined.

In addition, in the above-described embodiment, the case is described in which the standard work time corresponding to the level of the skill of the worker is compared with the actual work time, but the embodiment is not limited to such a case. For example, an average work time for each worker, which has been recorded in the worker skill DB, and the actual work time may be compared with each other.

In addition, in the above-described embodiment, the standard work time stored in the standard work time DB may be updated. For example, using an average value, a median value, a mode value or the like of average work time of the worker for the same work ID stored in the work history DB, the standard work time may be updated.

In addition, in the above-described embodiment, the case is described in which the work management program 50 and the worker terminal program 80 are respectively stored (installed) in the storage units 43 and 73 in advance, but the embodiment is not limited to such a case. The program may be provided so as to be stored in a storage medium such as a compact disc-read-only memory (CD-ROM), a digital versatile disc (DVD)-ROM, a universal serial bus (USB) memory.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A non-transitory, computer-readable recording medium having stored therein a program for causing a computer to execute a process comprising:
receiving, from a terminal, terminal location information indicating a location of the terminal carried by a worker;
transmitting a first control signal for causing the terminal to enter a first state in which work-start information indicating a start of work designated by a work instruction for instructing the worker to perform work is transmittable, based on a result of comparison between the terminal location information and work-instruction location information indicating a location at which work designated by the work instruction is to be performed by the worker;
receiving, from the terminal, the work-start information for the work instruction;
receiving, from the terminal, work-end information indicating an end of work designated by the work instruction;
comparing standard work information indicating a standard for the worker to perform work designated by the work instruction, with actual work information that is calculated based on the received work-start information and the received work-end information; and
outputting information on a result of the comparing.

2. The non-transitory, computer-readable recording medium of claim 1, wherein the standard work information is configured as information to which access by the worker is not allowed.

3. The non-transitory, computer-readable recording medium of claim 1, wherein the first control signal is transmitted when a distance between a location indicated by the terminal location information and a location indicated by the work-instruction location information is within a specific range.

4. The non-transitory, computer-readable recording medium of claim 1, further comprising
transmitting a second control signal for causing the terminal to enter a second state in which the work-end information is transmittable, based on a result of comparison between the terminal location information and the work-instruction location information.

5. The non-transitory, computer-readable recording medium of claim 4, wherein
the second control signal is transmitted when a distance between a location indicated by the terminal location information and a location indicated by the work-instruction location information is within a specific range.

6. The non-transitory, computer-readable recording medium of claim 1, wherein
the work-start information includes a work-start time indicating a time of starting work, the work-end information includes a work-end time indicating a time of ending work, and the standard work information includes a standard work time indicating a standard value of working time;
an actual work time indicating a time from the work-start time to the work-end time is calculated as the actual work information; and
a deviation between the standard work time and the actual work time is output as the result of the comparing.

7. The non-transitory, computer-readable recording medium of claim 6, wherein
the work-start information includes a work-start location indicated by the terminal location information at the work-start time, the work-end information includes a work-end location indicated by the terminal location information at the work-end time, and the standard work information includes a reference value of a distance of movement from a location indicated by the work-instruction location information;
a distance between the work-start location and the work-end location is calculated as the actual work information; and
a deviation of the calculated distance from the reference value of the distance of movement is output as the result of the comparing.

8. The non-transitory, computer-readable recording medium of claim 7, wherein
the actual work time is calculated when a deviation of the calculated distance from the reference value of the distance of movement is a specific value or less.

9. The non-transitory, computer-readable recording medium of claim 6, the process further comprising
transmitting a signal used to inquire about a reason for the deviation to the terminal when the deviation exceeds a specific threshold value.

10. The non-transitory, computer-readable recording medium of claim 6, wherein
the standard work time is a time corresponding to an average work time of each worker for each of works.

11. The non-transitory, computer-readable recording medium of claim 10, wherein
the standard work time is updated based on the average work time of each worker for each of the works.

12. A work management apparatus comprising:
a memory; and
a processor coupled to the memory and configured to:
receive, from a terminal, terminal location information indicating a location of the terminal carried by a worker, work-start information indicating a start of work designated by a work instruction for instructing the worker to perform work, and work-end information indicating an end of work designated by the work instruction,
transmit a first control signal, to the terminal, for causing the terminal to enter a state in which work-start information indicating a start of work designated by the work instruction is transmittable, based on a result of comparison between the terminal location information and work-instruction location information indicating a location at which work designated by the work instruction is to be performed by the worker,
compare standard work information, read from the memory, indicating a standard for the worker to perform work designated by the work instruction, with actual work information that is calculated based on the received work-start information and the received work-end information, and
output information on a result of the comparing.

13. A terminal apparatus comprising:
a memory; and
a processor coupled to the memory and configured to:
transmit location information indicating a location of the terminal apparatus,
receive, depending on the location information, a control signal for causing the terminal apparatus to enter a state in which work-start information indicating a start of work designated by a work instruction for instructing the worker to perform work is transmittable, and
control, based on the received control signal, the terminal apparatus to enter the state, and transmit the work-start information in accordance with an input from the worker.
